(19) United States
(12) Patent Application Publication
(10) Pub. No.: US 2016/0096455 A1
(43) Pub. Date: Apr. 7, 2016

(54) VEHICLE SEAT RETRACTABLE SECURING NET ASSEMBLY

(71) Applicant: Tracy Zimmerman, Bergen, NY (US)

(72) Inventor: Tracy Zimmerman, Bergen, NY (US)

(21) Appl. No.: 14/504,538

(22) Filed: Oct. 2, 2014

(51) Int. Cl. B60N 2/44

(52) U.S. Cl. CPC B60N 2/44; B60R 2011/0012

(57) ABSTRACT

A retractable securing net assembly for mounting on a conventional vehicle seat that enables items in a vehicle seat to be releasably restrained comprises an extendable retractable net in a deploying case and a plurality of mounting eyelets mounted on opposite sides of the target seat. The deploying case includes a spring loaded spool to which the retractable net is attached at one end and around which the retractable net, when in its retracted state, is wrapped. The retractable net additionally includes mounting hooks and a handle attached to an end bar disposed on its end opposite the attachment to the spool enabling the net to be pulled across the seat and hooked in place across the seat. Once the mounting hooks are disengaged from the mounting eyelets, the spring loaded spool retracts the retractable net, all the way up to the end bar, back into the deploying case.

### BACKGROUND OF THE INVENTION

1. Field of the Invention

This invention relates generally to securing apparatus and, more particularly, to a retractable securing net apparatus which can be selectively extended over items in passenger seating to hold them in place.

2. Description of the Prior Art

The storage and transportation of items in the cabin of a vehicle, particularly on the seats, is well known. A problem which often results from abrupt stops or other changes in direction is that items placed on a seat may slide or fall off to the floor. For some items, the impact from such a fall may result in the item breaking. But a more serious consequence, vehicle accidents, can arise from individuals attempting to retrieve fallen items while driving and taking their eyes off the road to do so. Thus, there remains a need for a retractable securing net assembly mounted on a vehicle seat and be placed over item in the seat to secure them in place. It would be helpful if such a vehicle seat retractable securing net assembly included a spring loaded retracting mechanism to place holding pressure against the seat back on items extended thereover. It would be additionally desirable for such a vehicle seat retractable securing net assembly to include mounting hooks for engaging seat mounting eyelets to hold net in an extended position across the seat.

The Applicant's invention described herein provides for retractable securing net assembly adapted to be placed on a vehicle seat and be extended over items in the seat to exert holding pressure against the seat back thereon. The primary components in Applicant's vehicle seat retractable securing net assembly are a retractable net, a deploying case, and a plurality of mounting eyelets. When in operation, the vehicle seat retractable securing net assembly enables items stored or transported in a vehicle seat to be secured in place, without a user holding them, by a structure that retracts when not in use.

### SUMMARY OF THE INVENTION

A retractable securing net assembly for mounting on a conventional vehicle seat that enables items in a vehicle seat to be releasably restrained. The vehicle seat retractable securing net assembly comprises a deploying case having disposed therein an extendable retractable net disposed on one side of the target seat and a plurality of mounting eyelets attached to eyelet mount body that is disposed on the other side of the target seat. The deploying case and the eyelet mount body are attached to a securing band that is removably disposed around the target seat. The deploying case includes a spring loaded spool to which the retractable net is attached at one end and around which the retractable net, when in its retracted state, is wrapped.

The retractable net additionally includes mounting hooks and a handle attached to an end bar disposed on its end opposite the attachment to the spool. In this regard, when handle is grasped and the net is pulled across the seat, the mounting hooks can engage the mounting eyelets, allowing the retractable net is held in place across the seat. Once the mounting hooks are disengaged from the mounting eyelets, the spring loaded spool retracts the retractable net, all the way up to the end bar, back into the deploying case.

It is an object of this invention to provide a retractable securing net assembly mounted on a vehicle seat and be placed over item in the seat to secure them in place.

It is another object of this invention to provide a vehicle seat retractable securing net assembly included a spring loaded retracting mechanism to place holding pressure against the seat back on items extended thereover.

It is yet another object of this invention to provide a vehicle seat retractable securing net assembly to include mounting hooks for engaging seat mounting eyelets to hold net in an extended position across the seat.

These and other objects will be apparent to one of skill in the art.

### BRIEF DESCRIPTION OF THE DRAWINGS

FIG. 1 is a front perspective view of a vehicle seat retractable securing net assembly built accordance with the present invention disposed on a vehicle passenger seat with the retractable net in the retracted position.

FIG. 2 is a front perspective view of a vehicle seat retractable securing net assembly built in accordance with the present invention with the retractable net extended.

FIG. 3 is a side elevational view of the extending handle of the retractable net of a vehicle seat retractable securing net assembly built accordance with the present invention.

FIG. 4 is a top plan view of a vehicle seat retractable securing net assembly built accordance with the present invention with the retractable net in the retracted position.

### DETAILED DESCRIPTION OF THE INVENTION

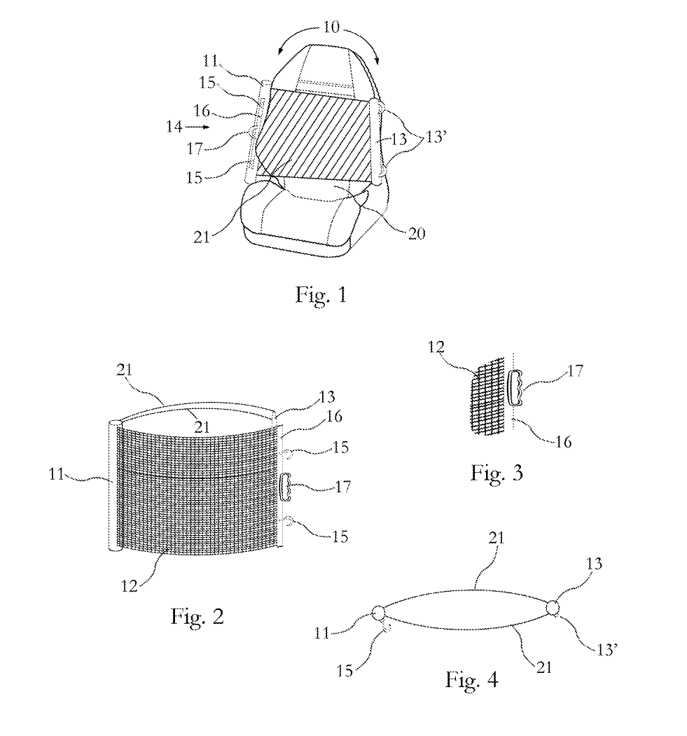

Referring now to the drawings and in particular FIGS. 1, 2, 3 and 4, a vehicle seat retractable securing net assembly 10 is shown disposed on a conventional vehicle seat, shown as the passenger seat 20 of a vehicle. The vehicle seat retractable securing net assembly 10 defines a deploying case 11 having disposed therein an extendable retractable net 12, and eyelet mount body 13 having two (2) mounting eyelets 13′. The deploying case 11 and the eyelet mount body 13 are attached a wrapping seat band 21 so as to form an attachment structure which can be placed over the passenger seat 20 and completely encircle it. When oriented in accordance with the present invention, the deploying case 11 is disposed on a first side of the seat and the eyelet mount body 13 is disposed to the passenger seat 20 on a second side, opposite the first side.

Internally, the deploying case 11 includes a spring loaded spool (not shown) to which the retractable net 12 is attached at one end and around which the retractable net 12, when in its retracted state, is wrapped. In this regard, the retractable net 11 can be extended from the deploying case 11 through the application of manual pressure in an extending direction 14, which brings the retractable net 11 out of the deploying case 11 across the seat 20 (and over any items in the seat 20). Once pulled across the seat 20, mounting hooks 15 attached to an end bar 16 of the retractable net 12 can be secured to the mounting eyelets 13. In this regard, the mounting hooks 15 and mounting eyelets 13 operate as a mounting clasp, allowing the retractable net 11 is held in place while extended across the seat 20. If the manual pressure in an extending direction 14 is removed without the mounting hooks 15 engaging the mounting eyelets 13, or if the mounting hooks 15 are disengaged from the mounting eyelets 13 without the application of manual pressure in an extending direction 14, the spring loaded spool retracts the retractable net 12, all the way up to the end bar 16, back into the deploying case 11.

A handle 17 is attached to the end bar 16 to provide a structure through which manual pressure in an extending direction 14 can be supplied. In the preferred embodiment, the handle 17 includes grooves for fingers and is one and one-half inches wide.

In the preferred embodiment, the mounting eyelets 13 and the mounting hooks 15 are constructed of plastic. In such an embodiment, the mounting eyelets 13 are attached to the seat such that they can bend forward to better allow the mounting hooks 15 to engage.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A vehicle seat retractable securing net, comprising:
an extendable net having at least one net mounting member connected thereto and disposed in a deploying case, wherein the deploying case is disposed on a first side of a target vehicle seat;
at least one seat mounting member, wherein the at least one seat mounting member is disposed on a second side of the target vehicle seat; and
wherein said at least one net mounting member is configured to engage said at least one seat mounting member thereby enabling said extendable net to be held in place, extended from said deploying case across the target vehicle seat to the at least seat mounting member.

2. The vehicle seat retractable securing net of claim 1, wherein said deploying case includes a spring loaded spool disposed therein and extendable net is permanently attached at one end to said spring loaded spool.

3. The vehicle seat retractable securing net of claim 2, wherein said extendable net includes an end bar at its end opposite the connection to the spring loaded spool and said at least one net mounting members are connected to said extendable net through an attachment to the end bar.

4. The vehicle seat retractable securing net of claim 1, wherein said extendable net includes an end bar at one end and said at least one net mounting members are connected to said extendable net through an attachment to the end bar.

5. The vehicle seat retractable securing net of claim 1, wherein each of said at least one net mounting members is defined by a mounting hook.

6. The vehicle seat retractable securing net of claim 1, wherein each of said at least one seat mounting members is defined by a mounting eyelet.

7. The vehicle seat retractable securing net of claim 1, wherein said at least one seat mounting members are attached to an eyelet mount body.

8. The vehicle seat retractable securing net of claim 1, wherein said deploying case and said eyelet mount body are attached to a seat band, thereby forming an attachment structure adapted to be placed over the target vehicle seat and completely encircle it.

9. A vehicle seat retractable securing net, comprising:
a deploying case having a spring loaded spool therein and attached to a seat band and oriented on a first side of a target vehicle seat;
an extendable net attached at one end to the spring loaded spool and having an end bar with two mounting hooks disposed at the opposite end, wherein said spring loaded spool biases the extendable net to retract into the deploying case up to the end bar;
two mounting eyelets disposed on an eyelet mount body, wherein said eyelet mount body is attached to the seat band and the eyelet mount body is oriented on a second side of the target vehicle seat and said seat band, deploying case and eyelet body mount form an attachment structure adapted to be placed over the target vehicle seat and completely encircle it; and
wherein said mounting hooks are configured to engage the mounting eyelets, thereby enabling said extendable net to be held in place, extended from said deploying case across the target vehicle seat to the mounting eyelets.
